(19) United States
(12) Patent Application Publication
(10) Pub. No.: US 2009/0094395 A1
(43) Pub. Date: Apr. 9, 2009

(54) KVM SWITCH HAVING A MEDIA AND INFORMATION CENTER AND MULTI-COMPUTER SYSTEM INCORPORATING THE SAME

(75) Inventor: Hsin-Mao SHEN, Taipei (TW)

Correspondence Address: YING CHEN;Chen Yoshimura LLP, 255 S. GRAND AVE., # 215, LOS ANGELES, CA, 90012, US

(73) Assignee: ATEN International Co., Ltd., Taipei (TW)

(21) Appl. No.: 12/325,780

(22) Filed: Dec. 1, 2008

Related U.S. Application Data
(63) Continuation-in-part of application No. 11/854,655, filed on Sep. 13, 2007.

(51) Int. Cl. G06F 13/00

(52) U.S. Cl. 710/74

(57) ABSTRACT

A KVM switch system is disclosed where the KVM switch is connected to data terminals of the computers to receive various data from the computers, such as system information of the computers, multimedia data retrieved from the computers, information downloaded from the Internet such as stock quotes, etc. Each computer executes a data generation program to generate the data. The KVM switch generates images based on the received data. The images may show data from all computers simultaneously. In one embodiment, the KVM switch has a touch screen panel to display the images. In another embodiment, the KVM switch generates the images and combines them with desktop images from a computer, and the combined image is displayed on the console monitor connected to the KVM switch. The KVM switch may emulate a CD-ROM for each computer and uses an auto-run file to load the data generation programs to the computer.

This application is continuation-in-part of U.S. application Ser. No. 11/854,655, filed Sep. 13, 2007, now pending, which is herein incorporated by reference in its entirety.

### BACKGROUND OF THE INVENTION

1. Field of the Invention

The invention relates in general to KVM switches, and more particularly to KVM switches displaying system information of computers connected thereto and a multi-computer system incorporating the same.

2. Description of the Related Art

A KVM switch (with KVM being an abbreviation for Keyboard, Video, and Mouse) is a hardware device that allows a user to control multiple computers from a single keyboard, video monitor and mouse. FIG. 1 shows the block diagram of a conventional multi-computer system. A console comprises a video monitor 102, a keyboard and a mouse (abbreviated as KB/MS 104), and an audio device 106. A KVM switch 108 controls the signal transmission between the devices of the console (102-106) and a plurality of computers (110 and 112). The KB/MS 104 inputs commands to control computer 1 (110) or computer 2 (112). The controlled computer (110 or 112) works according to the commands and outputs video and audio signals to the video monitor 102 and the audio device 106, respectively. In conventional techniques, a user can only communicate with one of the computers (110 or 112) via the devices of the console.

### SUMMARY OF THE INVENTION

A first embodiment of the invention discloses KVM switches comprising a body, a data transceiver, a micro control unit, and a display disposed on the body. The data transceiver receives data from a plurality of computers. The micro control unit analyzes and operates the received data to generate an image. The display displays the image. The data transceiver may communicate with the computers via a USB protocol, a wireless protocol, or a serial protocol.

The data provided by the computers are generated by application programs of the computers. In some implementations, the application program retrieves system information of the corresponding computer as the data. The system information may be CPU loading, CPU temperature, fan rotation, disc information, time, or date. The image displayed by the display is a list of the system information. In some implementations, the application program retrieves discs of the corresponding computer to get the data. The data retrieved from the discs may be photos, emails, notes, or address books. In some implementations, the application program downloads information from the internet as the data. The downloaded information may be the weather report or stock quotes.

In some implementations, the micro control unit further generates an on-screen display (OSD) to be displayed by the display.

In some implementations, the display is a touch panel. The micro control unit receives commands from the touch panel and transmits the commands to the computers. A user can communicate with the computers directly by the KVM switch of the embodiment without using the devices of the console (such as the video monitor, the KB/MS and the audio device).

Another embodiment of invention further discloses multi-computer systems utilizing the KVM switch. In addition to the KVM switch, the multi-computer system comprises a plurality of computers each comprising a data terminal for coupling to the data transceiver of the KVM switch.

Another embodiment of the invention further discloses KVM switches comprising a body, a display disposed on the body, a micro control unit, and a display driver. The micro control unit generates an on-screen display (OSD). The display driver is coupled between the micro control unit and the display to drive the display to show the OSD.

Another embodiment of the present invention provides a keyboard, video, mouse (KVM) switch which includes: a plurality of computer ports each for connecting to a computer, each computer port including a first video connection, a first input device connection, and a data connection; at least one console port each for connecting to a user console, each console port including a second video connection and a second input device connection; a video switching circuit coupled to the plurality of first video connections and outputting video signals from the first video connection of a selected one of the computer ports as first video signals; a processing circuit coupled to the plurality of data connections for receiving data from the plurality of computers and generating second video signals representing the received data; and a video combination circuit coupled to the video switching circuit and the processing circuit for combining the first and second video signals to generate a combined video signal for the second video connection.

Yet another embodiment of the present invention provides a method implemented in a keyboard, video, mouse (KVM) switch system, the system comprising a KVM switch, at least one user console connected to the KVM switch, and a plurality of computers connected to the KVM switch, the method including: (a) the KVM switch emulating a mass storage device for each computer, the emulated mass storage device containing a data generation program and an auto-run file; (b) the computers automatically download the data generation programs and executing them; (c) under the control of the data generation programs, the computers generating data and transfers the data to the KVM switch via the emulated mass storage device; (d) the KVM switch generating information display images representing the data received from the computers and combining the information display images with video signals from a selected one of the computers to generate combined video signals; and (e) the user console displaying the combined video signals.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 shows a block diagram of a conventional multi-computer system;

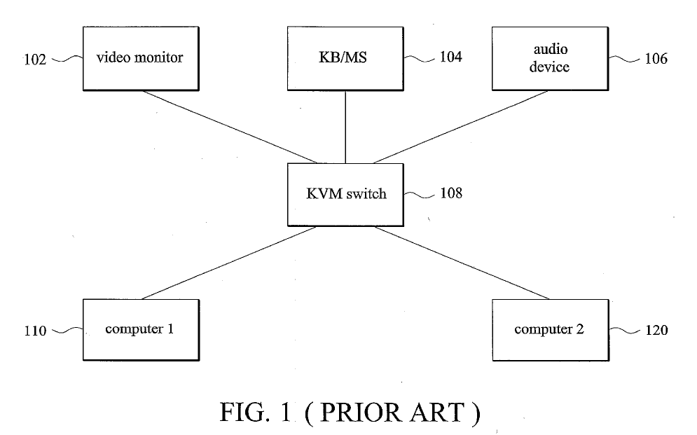

FIG. 2 shows a block diagram of a multi-computer system utilizing the KVM switch according to a first embodiment of the invention;

FIG. 3 illustrates a structure of the KVM switch of the first embodiment of the invention;

FIG. 4 shows a block diagram of a multi-computer system utilizing the KVM switch according to a second embodiment of the invention;

FIG. 5 shows a display screen displaying a desktop of one computer and a sidebar for media/information display according to the second embodiment;

FIG. 6 illustrates a practical example of operation of the KVM switch according to the second embodiment;

### DETAILED DESCRIPTION OF THE PREFERRED EMBODIMENTS

The following description is made for the purpose of illustrating the general principles of the invention and should not be taken in a limiting sense. The scope of the invention is best determined by reference to the appended claims.

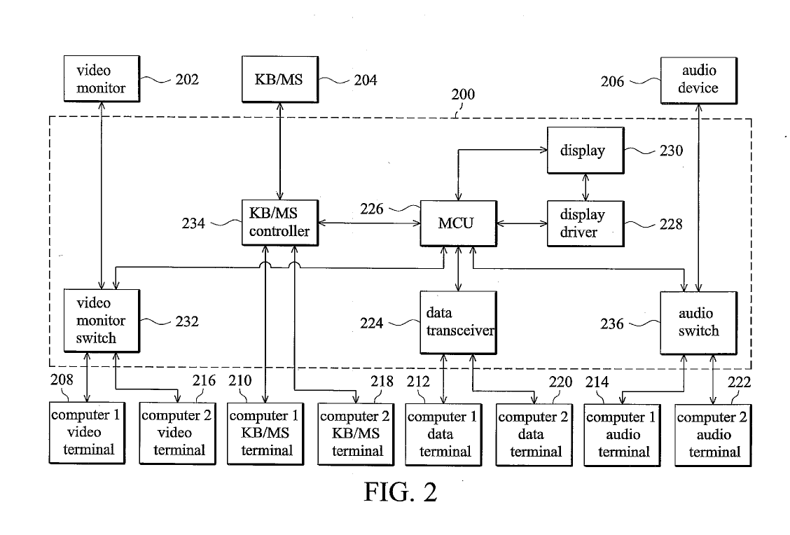

FIG. 2 shows a block diagram of a multi-computer system utilizing a KVM switch according to a first embodiment of the invention. The console comprises a video monitor 202, one or more user input devices such as a keyboard and a mouse (abbreviated as KB/MS 204), and an audio device 206. In this example, there are two computers (computer 1 and computer 2). The console controls the computers via the KVM switch 200. In conventional multi-computer systems, the computers each comprise a video terminal outputting a video signal, KB/MS terminals outputting KB/MS signals, and an audio terminal outputting an audio signal. Compared to conventional multi-computer systems, the computers in the first embodiment of the invention each further comprise a data terminal outputting data. In the embodiment shown in FIG. 2, computer 1 comprises a video terminal 208, KB/MS terminals 210, a data terminal 212, and an audio terminal 214. Computer 2 comprises a video terminal 216, KB/MS terminals 218, a data terminal 220, and an audio terminal 222. The KVM switch 200 comprises a video monitor switch 232, a KB/MS controller 234, and an audio switch 236. The video monitor switch 232 controls and routes the connection between the video monitor 202 and the video terminals of the computers (208 and 216) to set the video source of the video monitor 202. The audio switch 236 controls and routes the connection between the audio device 206 and the audio terminals of the computers (214 and 222) to set the audio source of the audio device 206. The KB/MS controller 234 controls the connection between the KB/MS 204 and the KB/MS terminals of the computers (210 and 218). The video monitor switch 232 and the audio switch 236 electrically switch the circuit connections. For the KB/MS controller 234, instead of electrically switching the circuit connection, the KB/MS controller 234 simulates the behavior of the KB/MS 204, continually transmitting information of the connections of the KB/MS 204 to the computers, because the computers have to always be connected with a keyboard and a mouse during operation. In one implementation, the audio device 206 may be a speaker or a socket port electrically inserted by an earpiece.

Referring to FIG. 2, the KVM switch 200 further comprises a data transceiver 224, a micro control unit (MCU) 226, a display driver 228, and a display 230. The data transceiver 224 receives data from the computers (computer 1 and computer 2) via the data terminal of computer 1 (212) and the data terminal of computer 2 (220). The data transceiver 224 may communicate with the computers (computer 1 and computer 2) via a USB (universal serial bus) protocol, a wireless protocol, or a serial protocol. The micro control unit 226 analyzes and operates the received data to generate an image. The display driver 228 is coupled between the micro control unit 226 and the display 230 to drive the display 230 to display the image generated by the micro control unit 226. The image may show data from all computers simultaneously. In one implementation, the MCU 226 and the display driver 228 may be integrated into a processing circuit or an ASIC.

The computers (computer 1 and computer 2) each comprises at least one application program generating the data. In one example, the application program retrieves system information of the corresponding computer as the data. The system information may be CPU loading, CPU temperature, fan rotation, disc information, time, or date. The image may show the system information of the computers in a list.

In another example, the application program accesses a storage device of the corresponding computer to retrieve the data. The data retrieved from the storage device may be photos, emails, notes, or address books. The micro control unit 226 generates an image comprising the retrieved data and the display driver 228 drives the display 230 to show the image.

In another example, the application program downloads information from a network database in the network as the data. The downloaded information may be the weather report or stock quotes. The micro control unit 226 generates an image comprising the information and the display driver 228 drives the display 230 to show the image. The network may be Internet, Ethernet, Intranet, Local area network (LAN), Wide area network (WAN) or wireless network.

In some implementations, the application programs are specifically designed to retrieve data from the computers that are in a standby or sleep mode. In these cases, the display 230 displays data from the computers (computer 1 and computer 2) even though the computers are in a standby or sleep mode.

In some implementations, the display 230 is a touch panel. The micro control unit 226 receives commands from the touch panel 230 and transmits the commands to the computers (computer 1 or computer 2). A user can directly communicate with the computers without using the devices of the console. For example, when the data are photos stored in the computers (computer 1 and computer 2), the micro control unit 226 generates an image comprising the pictures of the photos. The display driver 228 drives the display 230 to display the image. A user can select one photo by touching the display 230. The selection is transmitted to the micro control unit 226. After determining where the selected photo is located, the micro control unit 226 communicates with the computer comprising the selected photo via the data transceiver 224 to retrieve the selected photo. The selected photo is transmitted to the KVM switch 200 via the data transceiver 224 and displayed by the display 230. A user can directly retrieve one photo from the computers directly by the display 230 without using the devices of the console (202-206).

In some implementations, the micro control unit 226 generates an on-screen display (OSD). The display driver 228 drives the display 230 to show the OSD for expressing the work situation of the KVM switch 200. When the display 230 is a touch panel, a user can select a computer to control directly via the KVM switch 200 without using the devices of the console. A user may switch the connection between the console and the computers via the OSD in the display 230. In one implementation, the OSD is generated when the KVM switch 200 detects a predefined input from the console. The predefined input may be hot key of the keyboard, button click combination of the mouse, or the button of the monitor.

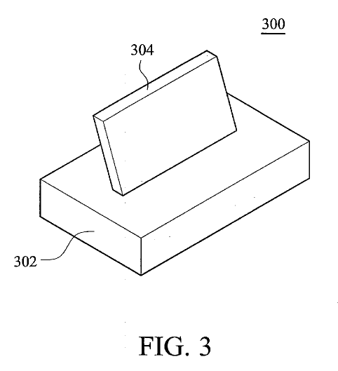

FIG. 3 illustrates the structure of the keyboard-video-mouse (KVM) switch of the first embodiment of the invention. The KVM switch 300 further comprises a body 302. A display 304 is disposed on the body 302. A user can control a plurality of computers via the KVM switch 300. Besides receiving commands from the console and outputting video and audio signals to the console via the KVM switch 300, the computers output data to the KVM switch 300. The data transceiver of the KVM switch 300 receives the data, and the micro control unit of the KVM switch 300 analyzes and operates the received data to generate an image. The image is displayed by the display 304. In some implementations, the display is a touch panel, and a user can communicate with the computers directly via the KVM switch 300 without using the devices of the console. In one implementation, the display 304 is vertically disposed on the body 302. In another implementation, the display 304 is horizontally disposed on the body 302. In another implementation, the display 304 is foldable and is disposed on the body 302.

In the first embodiment shown and described above, an application program is installed on each computer (e.g. compute 1 and computer 2) to generate the data and provide it to the KVM switch 200. A driver is also installed on each computer because the KVM emulates a special device. The driver is similar to a driver for a new USB device on a computer. Another limitation of the first embodiment is that the display 230 (e.g. a LCD screen) increases the cost of the KVM device 200. If a small LCD screen is used as the display 230 to reduce cost and reduce the overall size of the KVM switch, it will be inconvenient for displaying photographs and other data that would benefit from a high resolution display.

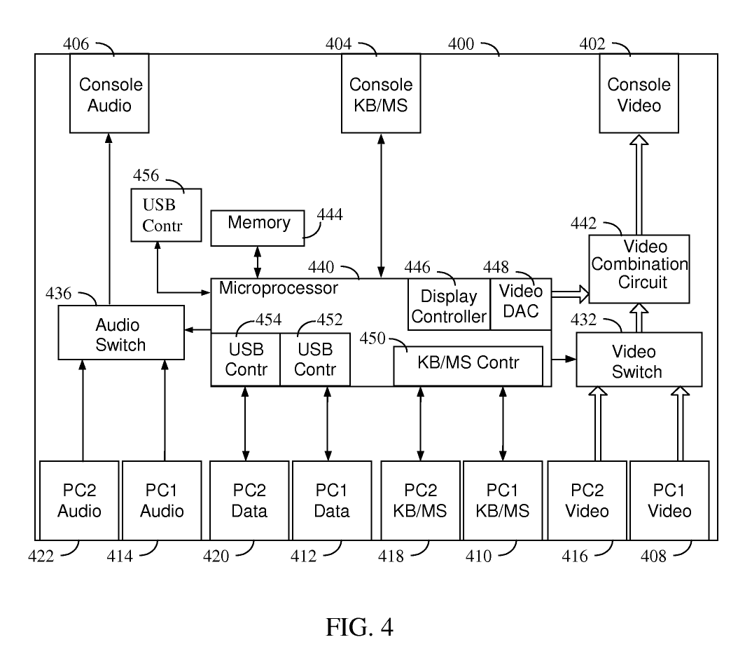

FIG. 4 shows a block diagram of a KVM switch for a multi-computer system according to a second embodiment of the invention. The KVM switch 400 has a console port for connecting to a user console, the console port including a video monitor connection 402, one or more user input device connection 404 such as a keyboard and mouse connection (abbreviated as KB/MS), and an audio device connection 406. In this example, the KVM switch has two computer ports for connecting to two computers denoted PC1 and PC2. The first computer port includes a PC1 video connection 408, PC1 KB/MS connection 410, PC1 data connection 412, and PC1 audio connection 414. The second computer port includes a PC2 video connection 416, PC2 KB/MS connection 418, PC2 data connection 420, and PC2 audio connection 422. In a preferred embodiment, the data connections 412 and 420 are USB connections connected to a USB port of the computers PC1 and PC2, respectively. The console selectively controls the computers via the KVM switch 400. The KVM switch 400 comprises a video switch 432, a control circuit (a microprocessor in this example) 440, an audio switch 236, a video combination circuit 442, and a memory 444.

The video switch 432 controls and routes the connection between the video monitor connection 402 and the video connections of the computers (408 and 416) to set the video source of the console video monitor. The audio switch 436 controls and routes the connection between the audio device connection 406 and the audio connections of the computers (414 and 422) to set the audio source of the console audio device. The video monitor switch 432 and the audio switch 436 electrically switch the circuit connections. The audio switch 436 may be an audio mixer which outputs audio signals from two or more computers ports to the console audio device.

The microprocessor 440 includes several functional components to perform several functions. A first function of the microprocessor 440 is to communicate and process data received from the computers. The microprocessor 440 includes a plurality of communication controllers to communicate with the computers using a communication protocol. In a preferred example, the communication controllers are USB device controllers 452, 454 communicating with the computers PC1, PC2 respectively using the USB protocol. In other examples, the communication controllers 452, 454 may use a wireless protocol, or a serial protocol. In the implementation illustrated in FIG. 4, the USB device controllers 452, 454 are shown as a part of the microprocessor 440, but they may also be implemented by component outside of the microprocessor 440 for practical reasons, especially when there is a large number of computers and a corresponding large number of USB device controllers. Data is received from the computers (PC1 and PC2) via the data connection of 412 and 420. The microprocessor 440 processes the received data, and generates images using a display controller 446 and a video digital-to-analog converter 448. The images, which represent the received data, may include data from any and all computers.

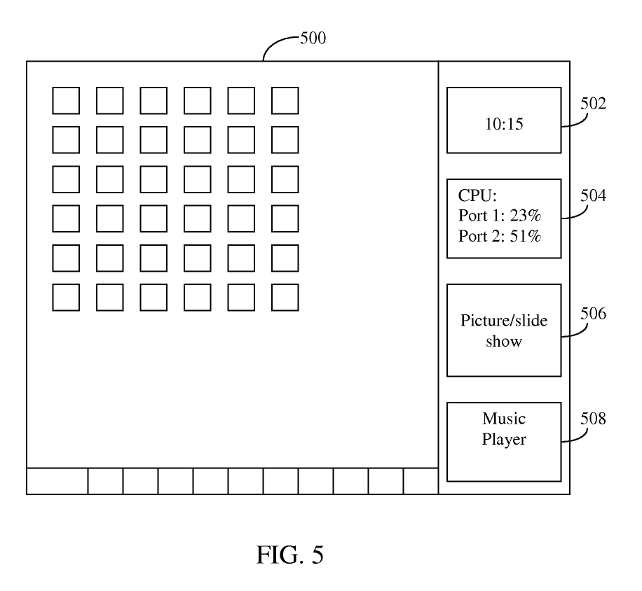

The video combination circuit 442 combines the images generated by the microprocessor 440 and desktop images of one of the computers PC1 or PC2 supplied by the video switch 432, and outputs the combined video signals to the video monitor connection 402. The images generated by the microprocessor 440 may be presented as small windows or icons of media/information display, and the windows or icons may be overlaid on the desktop image or displayed side-by-side with the desktop image. In one implementation, shown schematically in FIG. 5, the media/information windows are displayed as a side bar on the display screen 500. In this particular example, the media/information windows include a clock 502, a CPU Loading display 504, a picture display or slide show 506, and a music player interface 506. The left hand portion of the display screen 500 is the desktop of the computer being controlled by the user console. In an alternative implementation, the video combination circuit 442 overlays the media/information windows on the desk top image of the controlled computer; in other words, the media/information windows blocks a part of the desktop image. In anther alternative implementation, the media/information windows are displayed as semi-transparent windows over the desktop image. The user can change the size and position of the media/information windows, which may be accomplished by adjusting various parameters within the video combination circuit 442.

A second function of the microprocessor 440 is to control the connection between the KB/MS 404 and the KB/MS connections of the computers (410 and 418). A KB/MS controller 450 may be provided for this function. Instead of electrically switching the circuit connection, the microprocessor 440 simulates the behavior of the KB/MS 404, continually transmitting information of the connections of the KB/MS 404 to the computers, because the computers have to always be connected with a keyboard and a mouse during operation. In addition, the KB/MS controller determines whether the KB/MS signals are intended for the controlled computer or for the media/information windows. If they are intended for the controlled computer, the signals are processed and transferred to the controlled computer via the appropriate KB/MS connection 410 or 418. If the KB/MS signals are intended for the media/information windows, for example, when a use clicks the mouse within a music player window to play a particular song, the microprocessor 440 generates appropriate commands based on the input signals and transfers the commands to the relevant computer or computers via the PC data connections 412 and 420.

A third function of the microprocessor 440 is to transfer data generation programs to the computers (PC1 and PC2). The data generation programs are executed by the computers to generate various data, examples of which include: system information of the corresponding computer, such as CPU loading, CPU temperature, fan rotation, storage device information, time, date, etc.; data retrieved from a storage device of the computer, such as emails, notes, address books, photos, music, other multimedia data, etc.; and information downloaded from a network, such as weather report, stock quotes, etc. Instead of requiring the data generation programs to be pre-loaded onto the computers, the microcomputer 440 utilizes the USB controllers 452 and 454 to automatically load the data generation programs into the computers. When the data connection 412/420 for PC1/PC2 is connected to the KVM switch 400, the microprocessor 440 controls the USB controller 452/454 to emulate a USB CD-ROM device for the computer. The data generation program, which is pre-stored in the memory 444, is presented in the emulated CD-ROM device. The emulated CD-ROM device also contains an auto-run program, which causes the computer PC1/PC2 to automatically download the data generation program on to the computer and execute it. The data generation programs transfer data to the KVM switch 400 by writing the data to the emulated CD-ROM devices.

Because the emulated devices (USB CD-ROM) are standard devices, computers running popular operating systems such as Window, Mac, Linux, etc. can use their existing drivers to communicate with the USB controllers 452/454 without requiring any special driver to be installed on the computers. Methods for emulating a USB CD-ROM device are known in the art and more detailed descriptions are omitted here.

Although a CD-ROM is used as an example in the above description, the USB controllers 452 and 454 may also emulate other mass storage devices complying with the USB Mass Storage Class standard, such as DVD-ROMs, flash drives, hard disk drives, floppy disk drives, etc. CD-ROMs are preferred as the emulated devices because they provide convenient auto-run functions.

Note that components 446, 448, 450, 452, and 454 of the microprocessor 440 are functional components, and the implementation of them may be achieved by ASIC, FPGA, etc. They may alternatively be implemented as separate circuits.

In some implementations, the data generation application programs are specifically designed to retrieve data from the computers that are in a standby or sleep mode. In these cases, the image generated by the microprocessor 440 displays data from the computers even though the computers are in a standby or sleep mode.

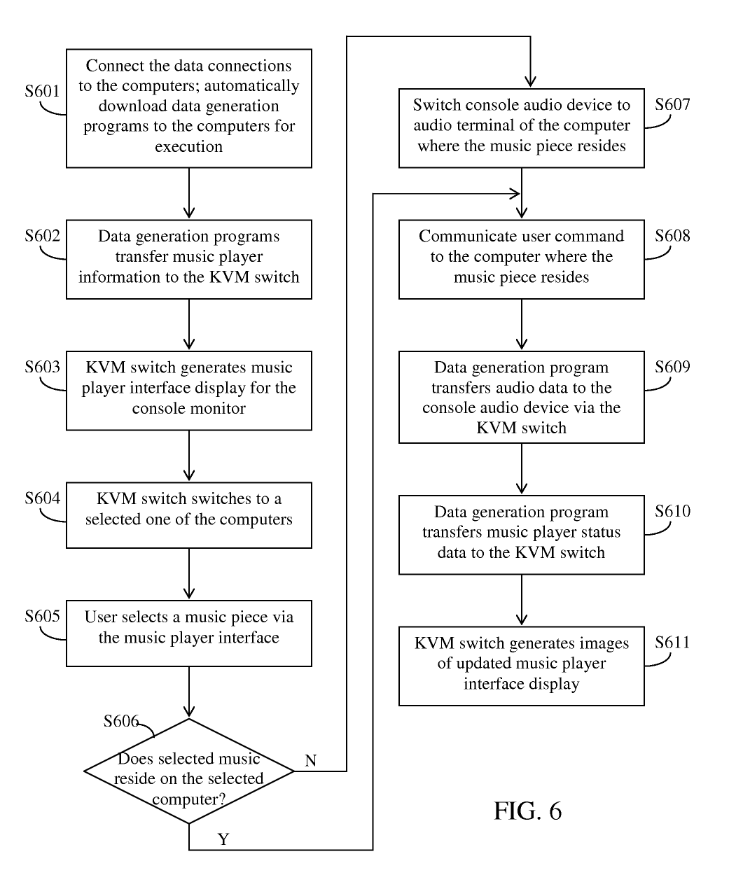

A practical example of the operation of the KVM switch 400 including the data display functions is described with reference to FIG. 6. In this example, the data is music player information and music data, but the operation for other types of information is similar. First, the data connections 412 and 420 are connected to the computers and data generation programs are downloaded from the emulated CD-ROM devices and executed on the computers PC1 and PC2 (step S601). The data generation programs gather information about music playing from the respective computers, such as the name and length of the musical pieces, the musician, etc. but not the entire music files, and transfer the information to the KVM switch 400 via the data connections 412 and 420 (step S602). The KVM switch generates images of a music player interface and combines it with the desktop image of the controlled computer for display on the console monitor (step S603). When the user switches the console to the first computer PC1, the PC1 video, and KB/MS connections 408 and 410 are connected with the user console (step S604).

At this time, if the user wishes to play a musical piece, he uses the music player interface on the screen to select the piece (step S605). If this piece resides on the first computer PC1 (“Y” in step S606), the KVM switch 400 communicates the user command (the selection of the music piece) to the data generation program on PC1 (step S608). This may be done by using the emulated CD-ROM channel. The data generation program executes an appropriate music player program to generate the audio data and transfers it to the KVM switch via the PC1 audio connection 414, and the KVM switch transfers it to the console audio device connection 406 for playing (step S609). In addition, the data generation program on PC1 transfers music player status information via the PC1 data connection 412 to the KVM switch 400 (step S610), and the KVM switch incorporates such information in the images generated by the display controller 446, so that updated music player status is included in the music player interface (step S611).

If, on the other hand, the user selected musical piece resides on the second computer PC2 (“N” in step S606), the audio switch 436 switches the console audio device connection 406 to the PC2 audio connection 422 (step S607). The subsequent steps S608, S609, S610 and S611 are then performed with respect to PC2. It should be noted that the order in which many steps in FIG. 6 are performed is not important.

It can be seen that while the KB/MS and video connections of one of the two computer ports are selectively connected to the user console port, the KVM switch 400 can simultaneously connect to the data connections of both computers PC1 and PC2. Thus, regardless of which computer is being controlled by the console, information from all computers can be simultaneously displayed in the media/information window on the user console.

The data being generated in the above example is audio (music), so a step of switching the audio connection (step S607) is performed. Alternatively, if the audio switch 436 is a mixer and can play audio signals from all computers simultaneously, and then the switching step S607 is not necessary. If the data being generated is visual data, such as pictures or slide shows, then the data is transferred via the PC1 and PC2 data connections 412, 420 and the switching step S607 is not performed.

The microprocessor 440 may organize the data received from multiple computers before generating the media/information display. In one practical example, the multiple computers transfer pictures (e.g. as bitmap images) to the KVM switch 400. The KVM switch 400 stores them, organizes all the pictures and displays them on the console monitor as a slide show that includes pictures from all of the multiple computers.

In some implementations, the microprocessor 440 generates an on-screen display (OSD) for managing the KVM switch 400 and performing other functions. The display controller 446 and the video DAC 448 generate images representing the OSD. The OSD may be generated when the KVM switch 400 detects a predefined input, such as a hot key or button click combination of the mouse, etc., from the console KB/MS connection 404. The OSD may be displayed by, for example, turning off the video switch 432 and outputting the OSD video to the console monitor.

Referring again to FIG. 4, the KVM switch 400 may optionally include a USB controller 456 and a USB port (not shown) to receive an external USB device, such as a flash memory device. The USB controller 456 is connected to the microprocessor 440. The KVM switch 400 retrieves data stored on the external USB memory and plays it on the user console. For example, if image files are stored in the external USB memory, the KVM switch 400 may generate a slide show by retrieving the images. In such a case, the console monitor functions as a digital picture frame. As another example, if MP3 music files are stored in the external USB memory, the music can be played on the console audio device by the KVM switch 400. In the latter case, an audio codec (not shown in FIG. 4) is provided between the USB controller 456 and the audio switch 436 to process the MP3 data. When the KVM switch 400 plays data from the external USB device, the computers PC1 and PC2 do not need to be connected to the KVM switch or turned on. If no computer is selected to be controlled by the user console, then the entire display screen of the console monitor can be used to display the data from the external USB device.

The second embodiment has some advantages as compared to the first embodiment. There is no need to pre-load the data generation program on the computers. The media/information display is displayed on the console monitor, and the KVM switch does not need to have a display screen, which reduces cost. The size and position of the media/information display windows can be flexible, and more info can be displayed as compared to the using the small screen on the KVM.

Both the first embodiment and the second embodiment can display media/information generated by all computers without changing the computer being controlled by the user console.

It will be apparent to those skilled in the art that various modification and variations can be made in the KVM switch system, the KVM switch and related method of the present invention without departing from the spirit or scope of the invention. Thus, it is intended that the present invention cover modifications and variations that come within the scope of the appended claims and their equivalents.

What is claimed is:

1. A keyboard, video, mouse (KVM) switch comprising:
a plurality of computer ports each for connecting to a computer, each computer port including a first video connection, a first input device connection, and a data connection;
at least one console port each for connecting to a user console, each console port including a second video connection and a second input device connection;
a video switching circuit coupled to the plurality of first video connections and outputting video signals from the first video connection of a selected one of the computer ports as first video signals;
a processing circuit coupled to the plurality of data connections for receiving data from the plurality of computers and generating second video signals representing the received data; and
a video combination circuit coupled to the video switching circuit and the processing circuit for combining the first and second video signals to generate a combined video signal for the second video connection.

2. The KVM switch of claim 1, wherein the data include one or more of system information of the computers, data retrieved from storage devices of the computers, and data downloaded from network databases.

3. The KVM switch of claim 1, wherein the system information includes one or more of CPU loading, CPU temperature, fan rotation, storage device information, time, and date,
wherein the data retrieved from the storage devices of the computers include one or more of emails, notes, address books, photos, and music, and
wherein the data downloaded from network databases include one or more of weather report and stock quotes.

4. The KVM switch of claim 1, wherein the second video signals represent data received from two or more of the plurality of computer ports simultaneously regardless of which computer port is the selected computer port.

5. The KVM switch of claim 1, wherein the control circuit processes user input device signals received from the second input device connection and outputs the processed signals to the first input device connection of the selected computer port.

6. The KVM switch of claim 1, wherein the control circuit processes user input device signals received from the second input device connection to generate a command regarding data display, and outputs the command to one or more computers via the data connections.

7. The KVM switch of claim 1,
wherein each computer port further includes a first audio connection,
wherein the console port further includes a second audio connection, and
wherein the KVM switch further comprises an audio switching device coupled to the plurality of first audio connections and outputting audio signals from selected one or more of the first audio connections to the second audio connection.

8. The KVM switch of claim 1, wherein the processing circuit includes a plurality of communication controller each coupled to one of the data connections of the computer ports, each communication controller emulating a mass storage device, the emulated mass storage device containing a data generation program to be downloaded to the computer connected to the data connection, wherein the data generation program is configured to cause the computer to generate the data and transmit the data to the KVM switch via the data connection.

9. The KVM switch of claim 8, wherein the emulated mass storage device further contains an auto-run file to cause the computer to automatically download the data generation program and execute it.

10. The KVM switch of claim 9, further comprising a memory for storing the data generation program and the auto-run file.

11. The KVM switch of claim 8,
wherein each computer port further includes a first audio connection,
wherein the console port further includes a second audio connection,
wherein the KVM switch further comprises an audio switching device coupled to the plurality of first audio connections and outputting audio signals from selected one or more of the first audio connections to the second audio connection, and
wherein the data generation program is further configured to cause the computers to generate audio signals and transmit the audio signals to the KVM switch via the first audio connections.

12. The KVM switch of claim 8, wherein the communication controllers are USB (universal serial bus) controllers, and wherein the emulated mass storage devices are emulated CD-ROM devices.

13. The KVM switch of claim 1, further comprising a communication controller for receiving external data from an external device.

14. The KVM switch of claim 13, wherein the external device is a USB memory device and wherein the external data include images or audio data.

15. The KVM switch of claim 1, wherein the processing circuit further generates images representing an on-screen display (OSD) as third video signals.

16. A method implemented in a keyboard, video, mouse (KVM) switch system, the system comprising a KVM switch, at least one user console connected to the KVM switch, and a plurality of computers connected to the KVM switch, the method comprising:
(a) the KVM switch emulating a mass storage device for each computer, the emulated mass storage device containing a data generation program and an auto-run file;
(b) the computers automatically download the data generation programs and executing them;
(c) under the control of the data generation programs, the computers generating data and transfers the data to the KVM switch via the emulated mass storage device;
(d) the KVM switch generating information display images representing the data received from the computers and combining the information display images with video signals from a selected one of the computers to generate combined video signals; and
(e) the user console displaying the combined video signals.

17. The method of claim 16, wherein the display images represent data received from two or more of the plurality of computers simultaneously regardless of which computer is the selected computer port.

18. The method of claim 16, further comprising:
(f) a user generating a user input using the information display images;
(g) the KVM switch generating a command based on the user input and transmitting the command to one or more of the computers via the emulated mass storage device; and
(h) under the control of the data generation programs and the command, the computers generating data and transfers the data to the KVM switch via the emulated mass storage device.

19. The method of claim 16, further comprising:
(i) the KVM switch storing and combining the data received from a plurality of computers and generating information display images representing the combined data.

20. The method of claim 16, further comprising:
(j) the KVM switch generating an OSD (on-screen display) image.
